(19) United States
(12) Patent Application Publication
(10) Pub. No.: US 2024/0001575 A1
(43) Pub. Date: Jan. 4, 2024

(54) SHEET CUTTING APPARATUS

(71) Applicant: BROTHER KOGYO KABUSHIKI KAISHA, Nagoya (JP)

(72) Inventors: Yusuke ARAI, Nagoya (JP); Isao KOBAYASHI, Nagoya (JP); Hiroaki TAKAHASHI, Nagoya (JP); Yoshimitsu TANIGUCHI, Tajimi (JP)

(21) Appl. No.: 18/345,488

(22) Filed: Jun. 30, 2023

(30) Foreign Application Priority Data
Jun. 30, 2022 (JP) 2022-106478

(51) Int. Cl. B26D 5/08; B65H 35/04

(52) U.S. Cl. CPC B26D 5/08; B65H 35/04

(57) ABSTRACT

There is provided a sheet cutting apparatus including: a cutter including first and second blades and a shifter including an actuator; a signal outputter; and a controller. The controller is configured to execute: a first cutting processing of moving the first blade in a cutting direction by setting a power value of the actuator to be a first power value; a first determining processing of determining whether abnormality in a moving state of the first blade exists; a first stopping processing of stopping the first blade at a first stop position, in a case that the abnormality is determined to exist; a first returning processing of moving the first blade upstream in the cutting direction; and a second cutting processing of moving the first blade in the cutting direction by setting the power value of the actuator to be a second power value greater than the first power value.

### REFERENCE TO RELATED APPLICATIONS

This application claims priority from Japanese Patent Application No. 2022-106478 filed on Jun. 30, 2022. The entire content of the priority application is incorporated herein by reference.

### BACKGROUND ART

The present disclosure relates to a sheet cutting apparatus having a cutting part (cutter) capable of cutting a sheet.

There is a publicly known technique wherein in a case that a recording paper (sheet) is cut by moving a movable blade with respect to a fixed blade, a determination is made as to whether or not the recording paper is present between the movable blade and the fixed blade by detecting a variation in an electric current of a cutter motor which causes the movable blade to move. In this technique, in a case that the recording paper is determined to be not present between the movable and fixed blades, a determination is made that the recording sheet is not conveyed up to a location between the movable and fixed blades and results in a paper jam (sheet jam).

### DESCRIPTION

Although a technique described in Japanese Patent Application Laid Open No. 2005-7592 is capable of determining as to whether or not the paper jam has occurred, the technique is unable to detect a sign of a phenomenon in which the movable blade runs onto (rides over) the fixed blade (hereinafter referred to as “running-on”) and is unable to reduce occurrence of this phenomenon. The running-on might occur due to a load applied to the movable blade by, for example, a thickness of the recording paper which is great, any double-feeding of the recording paper, etc. Once the running-on occurs, it is not possible to cut the recording sheet.

An object of the present disclosure is to provide a sheet cutting apparatus capable of detecting the sign of the running-on and capable of reducing occurrence of the running-on.

According to a first aspect of the present disclosure, there is provided a sheet cutting apparatus including:
a conveyor configured to convey a sheet in a conveying direction;
a cutter including a first blade configured to make contact with a first surface of the sheet conveyed by the conveyor, a second blade configured to make contact with a second surface, opposite to the first surface, of the sheet, and a shifter configured to move the first blade in a cutting direction, the cutter being configured to cut the sheet in the cutting direction by cooperation of the first blade and the second blade;
a signal outputter configured to output a signal depending on a moving state of the first blade moved by the shifter; and
a controller.

The shifter includes an actuator configured to apply a power for moving the first blade.

The controller is configured to execute:
a first cutting processing of moving the first blade in the cutting direction toward a first target position, by setting a power value of the actuator to be a first power value;
a first determining processing of determining whether abnormality in the moving state of the first blade exists or not, based on the signal outputted from the signal outputter, during executing of the first cutting processing;
a first stopping processing of stopping the first blade at a first stop position upstream in the cutting direction of the first target position by stopping the power of the actuator, in a case that the abnormality in the moving state of the first blade is determined to exist in the first determining processing;
a first returning processing of moving the first blade upstream in the cutting direction, after the first stopping processing; and
a second cutting processing of moving the first blade in the cutting direction from a position upstream in the cutting direction of the first stop position toward a second target position by setting the power value of the actuator to be a second power value greater than the first power value, after the first returning processing, the second target position being a position same as the first target position or a position upstream in the cutting direction of the first target position and downstream in the cutting direction of the first stop position.

According to a second aspect of the present disclosure, there is provided a sheet cutting apparatus including:
a conveyor configured to convey a sheet in a conveying direction;
a cutter including a first blade configured to make contact with a first surface of the sheet conveyed by the conveyor, a second blade configured to make contact with a second surface, opposite to the first surface, of the sheet, and a shifter configured to move the first blade in a cutting direction, the cutter being configured to cut the sheet in the cutting direction by cooperation of the first blade and the second blade;
a signal outputter configured to output a sign signal being a signal indicating a sign of running-on of the first blade moved by the shifter to the second blade; and
a controller configured to execute a first stopping processing of stopping the first blade in a case that the controller detects the sign signal.

According to the present disclosure, it is possible to detect the sign of the running-on and to reduce the occurrence of the running-on.

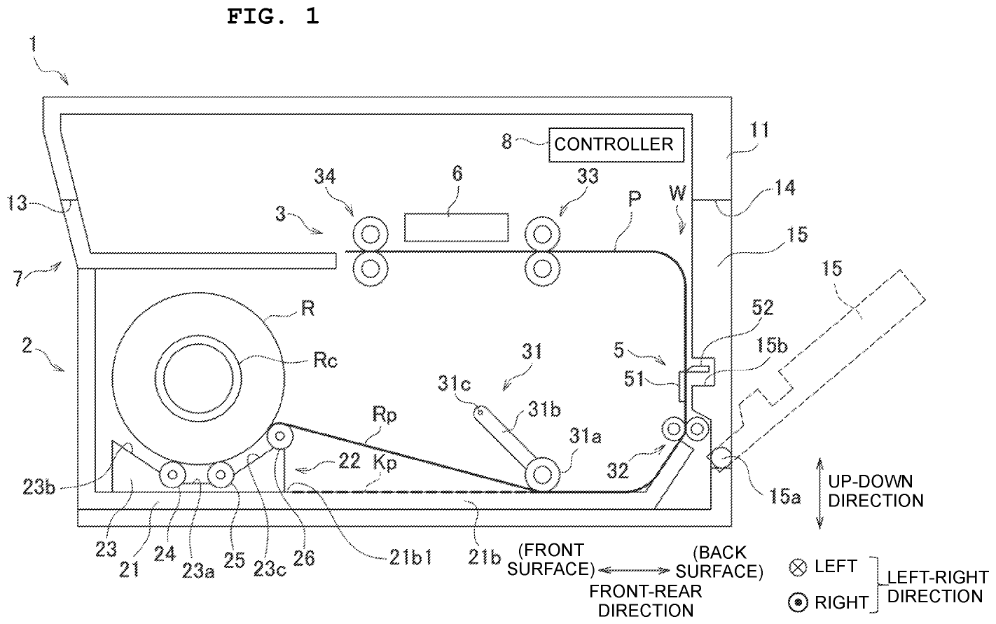

FIG. 1 is a side view depicting the schematic configuration of a printer.

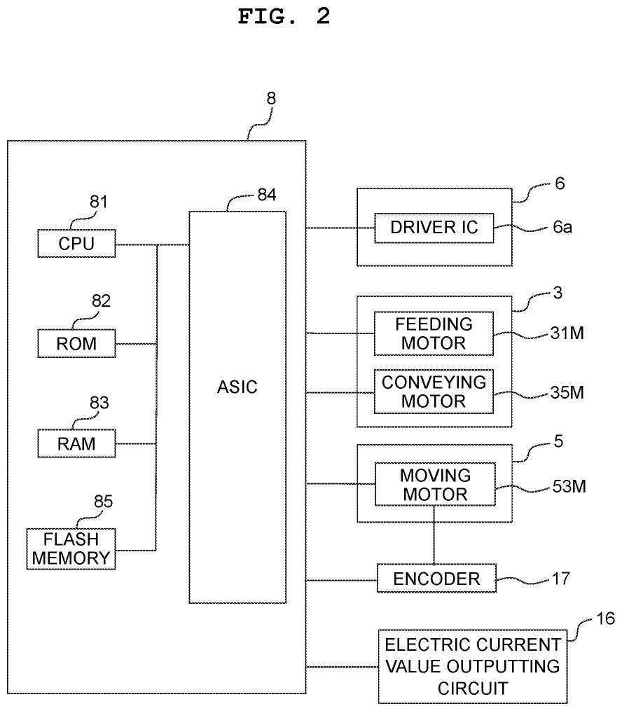

FIG. 2 is a block diagram of a controller of the printer depicted in FIG. 1.

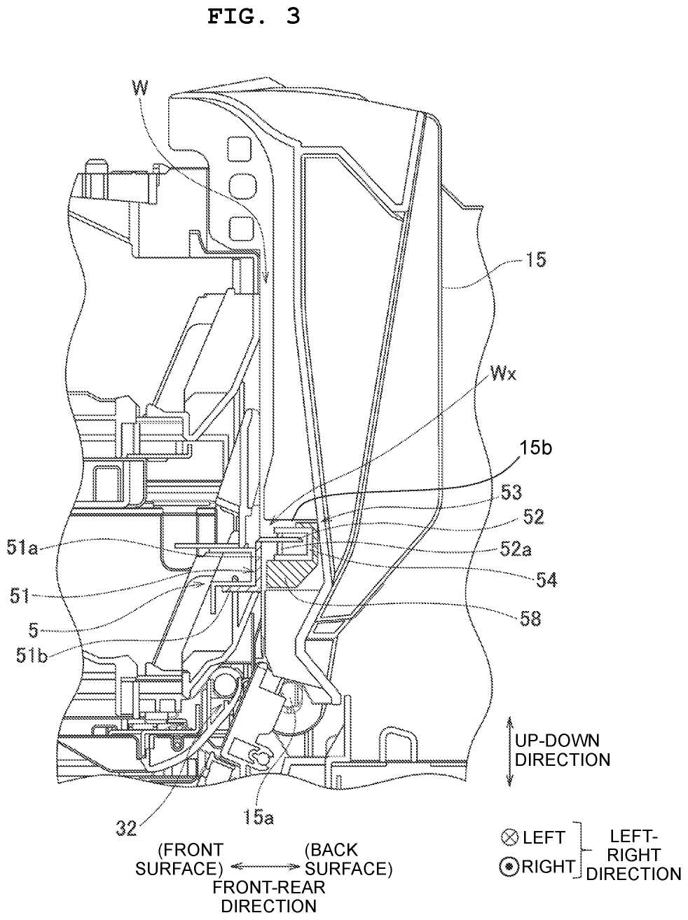

FIG. 3 is a lateral cross-sectional view depicting a cover and a cutting part.

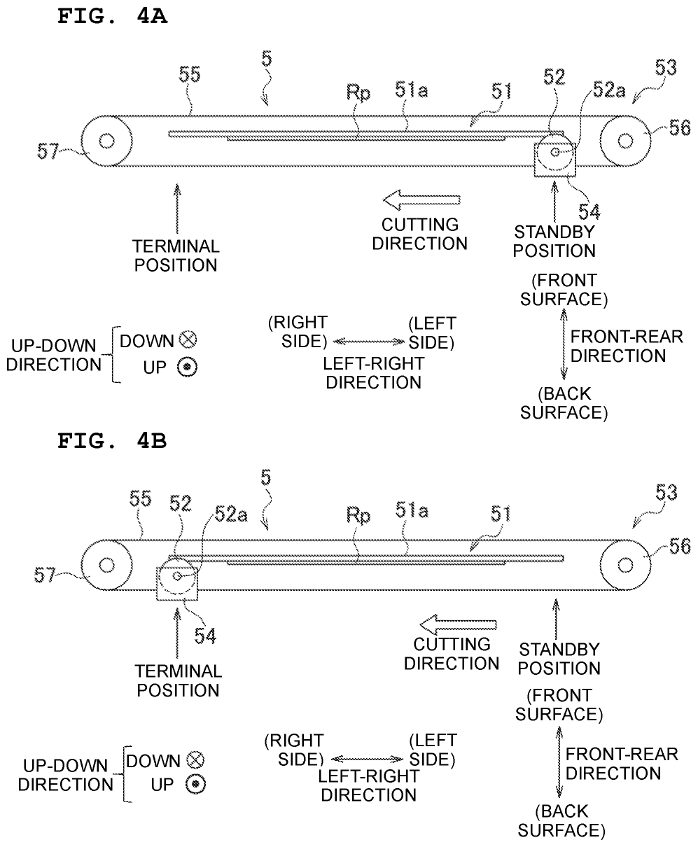

FIGS. 4A and 4B are each a schematic plan view of the cutting part depicted in FIG. 1, wherein FIG. 4A is a view depicting a situation that a rotary blade and a carriage are arranged at a standby position, and FIG. 4B is a view depicting a situation that the rotary blade and the carriage are arranged at a terminal position.

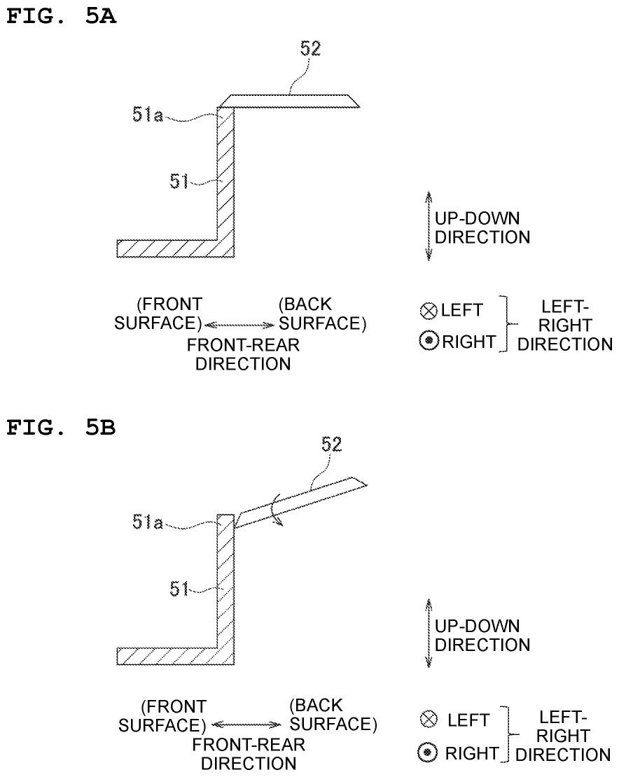

FIGS. 5A and 5B are each a partially enlarged view of FIG. 3, wherein FIG. 5A is a view depicting a normal state, and FIG. 5B is a view depicting a state that running-on has occurred.

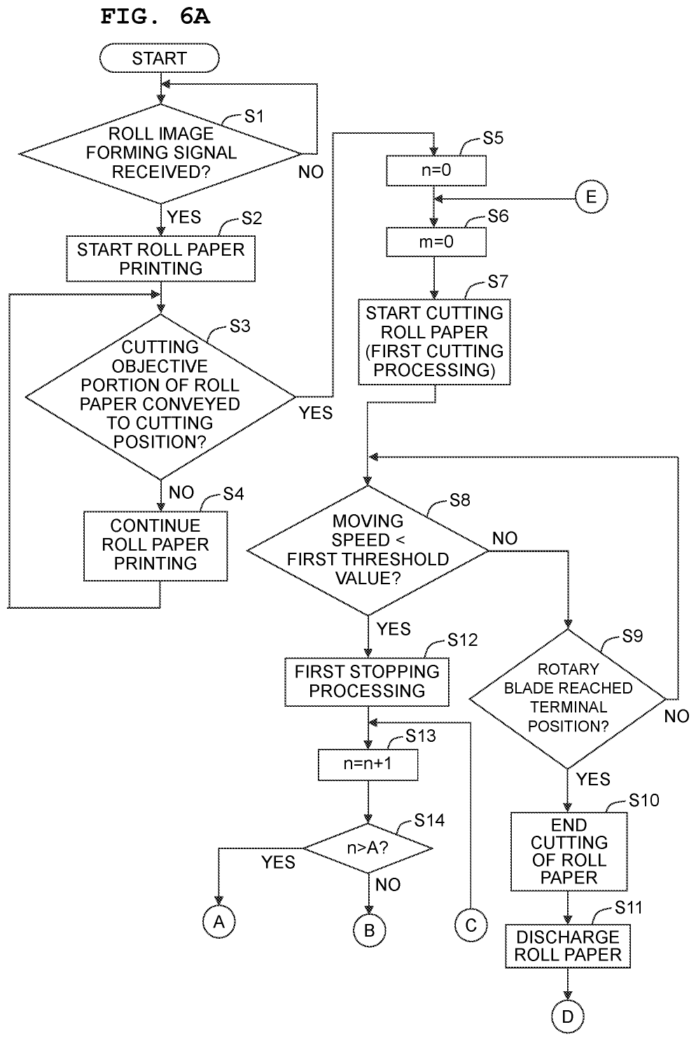

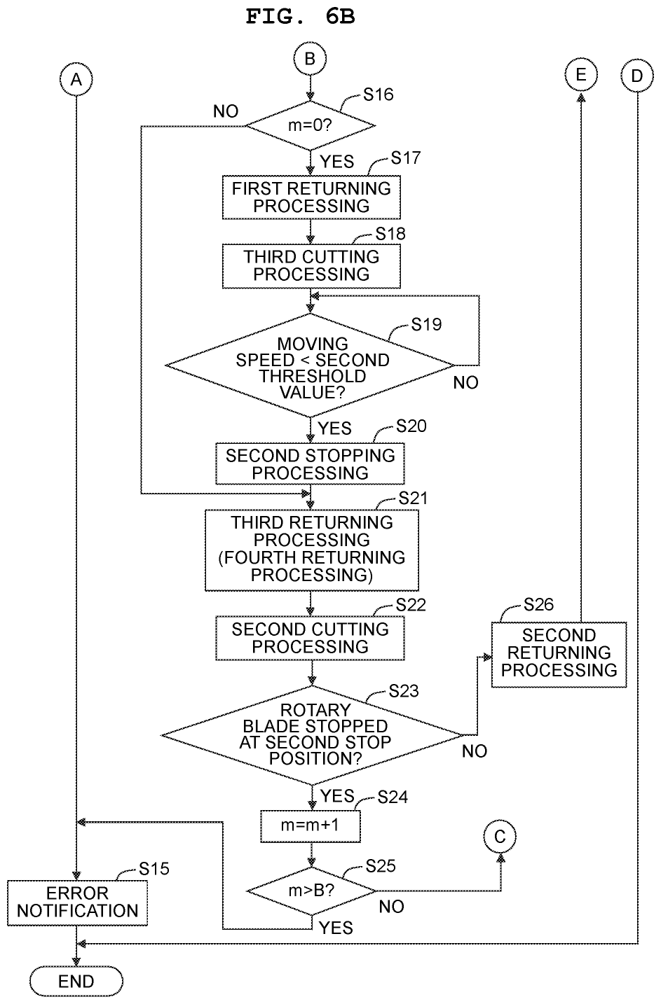

FIGS. 6A and 6B are flow charts indicating a program executed by a controller of the printer depicted in FIG. 1.

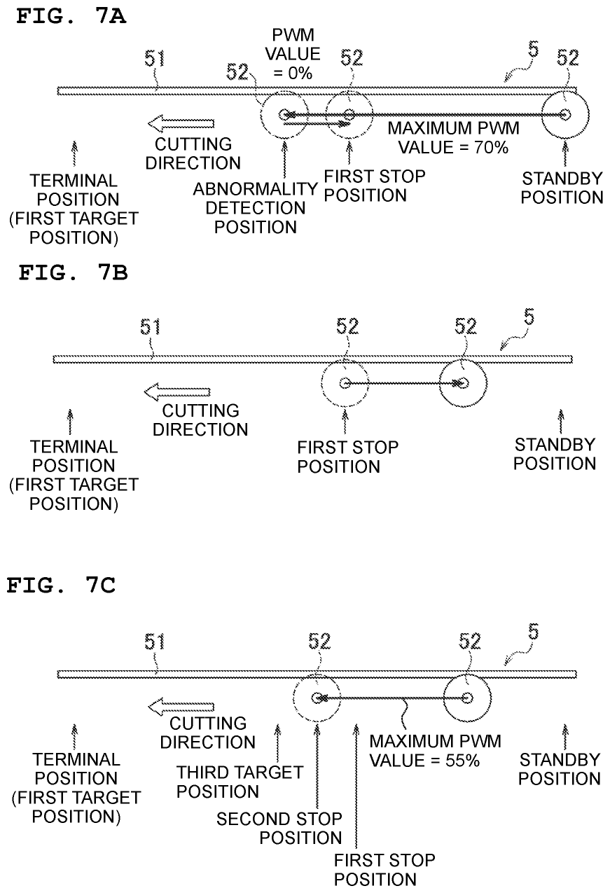

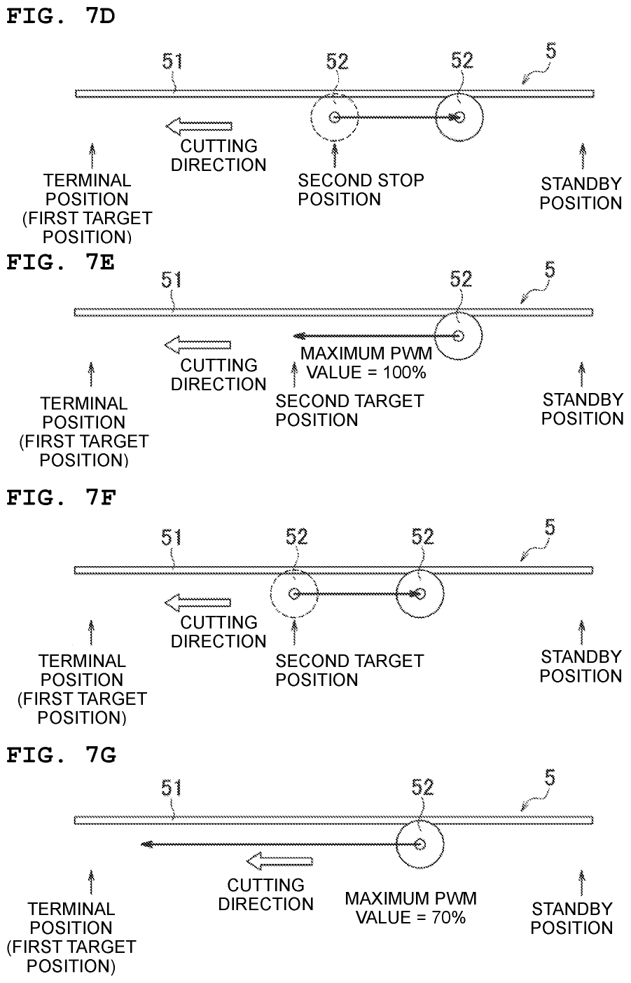

FIGS. 7A to 7G are schematic plan views of the cutting part, depicting a processing in a case that abnormality has occurred in a moving state of the rotary blade.

In the following, a printer 1 (an example of a “sheet cutting apparatus”) according to an embodiment of the present disclosure will be described, with reference to the drawings. In the following description, the up-down direction is defined, with a state in which the printer 1 is installed usably (a state of FIG. 1), as the reference; the front-rear direction is defined, with a side on which a discharge port 13 of a casing 11 is provided is defined as a front side (front surface or frontward) and with a side on which an opening 14 is provided is defined as a rear side (back surface or rearward); and the left-right direction is defined, with the printer 1 as seen from the front side (front surface).

As depicted in FIG. 1, the printer 1 has: a feed cassette 2, a conveying part 3 (an example of “conveyor”), a cutting part 5, a head 6, a discharge tray 7, a controller 8, a casing 11, a cover 15, an electric current value outputting circuit 16 (see FIG. 2), an encoder 17 (see FIG. 2), etc.

The feed cassette 2 is arranged in the inside of the casing 11 at a location below the head 6. The discharge tray 7 is arranged in the inside of the casing 11 at a location which is in front of the head 6 and which is above the feed cassette 2. The feed cassette 2 and the discharge tray 7 are insertable along the front-rear direction into inside of the casing 11, via the opening 13 provided on the front surface of the casing 11. Further, the feed cassette 2 installed in the casing 11 is detachable along the front-rear direction via the opening 13. Further, the discharge tray 7 installed in the casing 11 can be pulled frontward via the opening 13.

The feed cassette 2 selectively store or accommodates a sheet P (an example of “sheet”) being a roll body R or the sheet P (an example of “sheet”) being a cut paper Kp. In the roll body R, a long roll paper Rp is wound in a roll shape around an outer circumferential surface of a cylindrically shaped roll core (paper tube) Rc. As depicted in FIG. 1, the feed cassette 2 has: a tray 21 having a box-like shape which is opened upward and a supporting part 22 which rotatably supports the roll body R while supporting the outer circumferential surface of a lower-side part of the roll body R. The cut paper sheet Kp is arranged on a part, of a bottom surface 21b1 of the tray 21, which is located on the rear side with respect to the supporting part 22, or on the entirety of the bottom surface 21b1 from which the supporting part 22 is detached.

The supporting part 22 has a supporting stand 23 and three rollers 24 to 26. The roll body R is supported by the supporting part 22 in a posture, of the roll body R, in which an axial direction of the roll body R is parallel to the left-right direction (a direction orthogonal to a sheet surface of FIG. 1). The supporting stand 23 is provided detachably installable with respect to a bottom part 21b of the tray 21. The supporting stand 23 extends along the left-right direction. Each of the rollers 24 to 26 is rotatably supported by the supporting stand 23 in a posture thereof in which an axial direction thereof is parallel to the left-right direction.

The supporting stand 23 has a horizontal surface 23a and two inclined surfaces 23b and 23c which are arranged, respectively, at positions sandwiching the horizontal surface 23a in the front-rear direction. The roller 24 is arranged at a rearward part of the inclined surface 23b and arranged at a front side with respect to the roller 25. The roller 25 is arranged at a frontward part of the inclined surface 23c and the roller 26 is arranged at a rearward part of the inclined surface 23c. The rollers 24 and 25 support the roll body R from therebelow, in a state that the rollers 24 and 25 are in contact with the outer circumferential surface of the lower-side part of the roll body R.

The cover 15 is arranged at the opening 14 provided on the back surface of the casing 11. A lower end part of the cover 15 is rotatably supported by a shaft 15a supported by the casing 11. The shaft 15a extends in the left-right direction (the direction orthogonal to the sheet surface of FIG. 1). The cover 15 rotates about the shaft 15a to be a close position (a position indicated by solid lines in FIG. 1) and an open position (a position indicated by broken lines in FIG. 1). The cover 15 at the close position forms a conveyance route W, of the sheet P, in which the sheet P is conveyed by the conveying part 3 and which is defined by the cover 15 and a non-depicted guide provided in the inside of the casing 11. Further, in a case that the cover 15 is in the open position, a part of the conveyance route W is thereby opened or released.

The conveying part 3 has a feeding part 31, three conveying roller pairs 32 to 34 and a conveying motor 35M (see FIG. 2). The feeding part 31 feeds the sheet P, which is accommodated in the feed cassette 2, rearward from the feed cassette 2.

The feeding part 31 is arranged at a location above the feed cassette 2, and has a feeding roller 31a, an arm 31b and a feeding motor 31M (see FIG. 2). The feeding roller 31a is pivotally supported by a forward end of the arm 31b. The arm 31b is rotatably supported by a support shaft 31c. The arm 31b is urged by a spring, etc., to a direction in which the feeding roller 31a makes contact with the bottom surface 21b of the tray 21. Further, the arm 31b is configured to be retractable upward in a case that the tray 21 is attached and detached. The feeding roller 31a is rotated by a power applied thereto from the feeding motor 31M. In a case that the feeding motor 31M is driven by a control of the controller 8, the feeding roller 31a is rotated thereby, which in turn feeds the sheet P accommodated in the inside of the tray 21 rearward.

The three conveying roller pairs 32 to 34 convey the sheet P fed by the feeding part 31 in the inside of the casing 11 along a conveying direction orthogonal to the left-right direction. The three conveying roller pairs 32 to 34 are arranged in this order from an upstream side in the conveying direction. The conveying roller pair 32 conveys the sheet P fed from the feed cassette 2 by the feeding part 31. The sheet P fed by the conveying roller pair 32 is first fed upward in a posture in which one surface of the sheet P faces rearward and the other surface of the sheet P faces frontward, passes the cutting part 5 and then is fed frontward. The conveying roller pair 33 receives the sheet P conveyed by the conveying roller pair 32, and feeds the sheet P to the head 6. The conveying roller pair 34 receives the sheet P conveyed by the conveying roller pair 33 and discharges the sheet P. The sheet P conveyed by the conveying roller pairs 33 and 34 is fed frontward.

Each of the conveying roller pairs 32 to 34 is constructed of a driving roller which rotates by a power applied thereto from the conveying motor 35M and a driven roller which rotates following the rotation of the driving roller. In a case that the conveying motor 35M is driven by a control of the controller 8, the driving roller and the driven roller of each of the conveying roller pairs 32 to 34 rotate in a state that the sheet P is nipped by the driving roller and the driven roller, thereby conveying the sheet P in the conveying direction.

The head 6 is arranged at a location between the conveying roller pair 33 and the conveying roller pair 34. The head 6 includes a plurality of nozzles (not depicted in the drawings) formed in a lower surface of the head 6, and a driver IC 6a (see FIG. 2). In a case that the driver IC 6a (see FIG. 2) is driven by a control of the controller 8, the head 6 ejects or discharges an ink supplied from an ink cartridge (not depicted in the drawings) from the nozzles so as to form an image with respect to the sheet P which is conveyed by the conveying roller pair 33. The sheet P on which the image is formed is conveyed by the conveying roller pair 34 frontward (toward the left in FIG. 1). Note that the head 6 may be either one of a head of a line system which ejects the ink from the plurality of nozzles in a state that a position of the head 6 is fixed, or a head of a serial system in which the head 6 ejects the ink from the plurality of nozzles while head 6 is moved in the left-right direction (a main scanning direction).

The discharge tray 7 receives the sheet P conveyed frontward by the conveying roller pair 34. The sheet P accommodated in the discharge tray 7 is a roll paper Rp in which a rear end is formed by the cutting part 5 and the image is formed thereon by the head 6 and/or a cut paper Kp in which the image is formed by the head 6.

As depicted in FIG. 1, the cutting part 5 is arranged at a location which is between the conveying roller pairs 32 and 33 in the conveying direction and which is above the conveying roller pair 32. The cutting part 5 has a fixed blade 51, a rotary blade 52 and a moving mechanism 53 (an example of “shifter”, see FIGS. 4A and 4B); the cutting part 5 cuts the roll paper Rp which passes a route Wx (see FIG. 3; a part of the conveyance route W) between the fixed blade 51 and the cover 15 in a direction from left to right (an example of “cutting direction”) by cooperation of the fixed blade 51 and the rotary blade 52. In the present disclosure, the cutting direction is a direction orthogonal to the conveying direction and along a width direction of the roll paper Rp.

As depicted in FIG. 3, the fixed blade 51 (an example of “second blade”) has a vertical part 51a and a horizontal part 51b and is formed to have a L-shaped cross section. The fixed blade 51 is fixed to the casing 11. The vertical part 51a is provided to extend upward from a rear end part of the horizontal part 51b. Further, as depicted in FIGS. 4A and 4B, the fixed blade 51 extends to be long in the left-right direction. More specifically, the fixed blade 51 is formed to be longer than a width (a length in the left-right direction) of the roll paper Rp. The vertical part 51a of the fixed blade 51 is arranged to be capable of making contact with a surface, of the roll paper Rp moving through the route Wx, which faces (is oriented) frontward (an example of “second surface”).

In a case that the cover 15 is at the close position (the position indicated by the solid lines in FIG. 1), the rotary blade 52 (an example of a “first blade”) is positioned inside a groove 15b formed in the surface, of the cover 15, which is oriented frontward. The rotary blade 52 is mounted on a carriage 54 (described later on. See FIG. 4) which is movable along the left-right direction. As depicted in FIG. 3, the rotary blade 52 is disc-shaped, and is supported by the carriage 54 to be rotatable about a shaft 52a extending in the up-down direction. Further, the rotary blade 52 is arranged to be capable of making contact with a surface, of the roll paper Rp moving through the route Wx, which is oriented rearward (an example of “first surface”).

In a normal state of the rotary blade 52, as depicted in FIG. 3 and FIG. 5A, the rotary blade 52 is arranged so that a front end part of the rotary blade 52 is capable of making contact with an upper end surface of the vertical part 51a of the fixed blade 51. However, there arises such a case that the rotary blade 52 runs onto the fixed blade 51 due to a load applied to the rotary blade 52 caused by, for example, a thickness of the sheet P which is great, any double-feeding of the sheet P, etc., as depicted in FIG. 5B. Once this phenomenon (running-on) occurs, the front end part of the rotary blade 52 does not make contact with the upper end surface of the vertical part 51a of the fixed blade 51, and thus even in a case that the rotary blade 52 is moved in the cutting direction in this state, it is not possible to cut the sheet P. It is difficult for the user to restore the rotary blade 52 in which the running-on has occurred to the normal state (see FIG. 5A). Further, if the printing operation is stopped in a case that the running-on has occurred, it is inconvenient for the user. In view of this situation, in the present disclosure, the controller 8 executes a program (to be described later on; see FIGS. 6A and 6B) in order to detect a sign of the running-on and to reduce occurrence of this running-on phenomenon.

As depicted in FIGS. 4A and 4B, the moving mechanism 53 has: the carriage 54, a belt 55, a pair of pulleys 56 and 57, a guide rail 58 (see FIG. 3) and a moving motor 53M (an example of an “actuator”; see FIG. 2). As depicted in FIG. 3, the entirety of the guide rail 58 is arranged in the groove 15b of the cover 15 which is arranged at the close position. Further, the guide rail 58 is formed to be elongated along the left-right direction, and supports the carriage 54 to be movable in the left-right direction.

As depicted in FIGS. 4A and 4B, the carriage 54 supports the rotary blade 52 to be rotatable, and the carriage 54 is fixed to the belt 55. The pair of pulleys 56 and 57 are arranged to be apart from each other, such that the route Wx is interposed between the pulley 56 and the pulley 57 in the left-right direction. The pulley 56 is a driving pulley to which a power is applied by the moving motor 53M. The belt 55 is a ring-shaped endless belt and stretched between the pair of pulleys 56 and 57. The pulley 57 is a driven pulley rotated by the belt 55 which runs by the rotation of the pulley 56.

As depicted in FIG. 4A, the carriage 54 is normally arranged at a standby position at a left end part of the fixed blade 51. In this situation, the rotary blade 52 is also arranged at the standby position. Further, in a case of cutting the roll paper Rp, the moving motor 53M is driven to rotate in a normal direction by the control of the controller 8 to thereby run the belt 55, which in turn causes the rotary blade 52 to move rightward together with the carriage 54. In this situation, the rotary blade 52 rotates by friction between the rotary blade 52 and the fixed blade 51. With this, the fixed blade 51 and the rotary blade 52 cooperate with each other so as to cut the roll paper Rp in the route Wx, in the cutting direction. In such a manner, a rear end of the roll paper Rp is formed. As depicted in FIG. 4B, the carriage 54 and the rotary blade 52 moved rightward are made to stop at a terminal position at a right end part of the fixed blade 51, by stopping the driving of the moving motor 53M. Afterward, the moving motor 53M is driven to rotate in a reverse direction to cause the rotary blade 52 to move leftward together with the carriage 54, thereby returning the rotary blade 52 to the standby position as depicted in FIG. 4A.

The encoder 17 (see FIG. 2) is provided on a part at which the power is transmitted from the moving motor 53M to the pulley 56. The encoder 17 (an example of a “signal outputter”) outputs a signal indicating a position and a moving speed of the rotary blade 52 (A signal in depending on a moving state of the rotary blade 52. An example of a “signal”). The encoder 17 may be, for example, a rotary encoder, a linear encoder, etc.

Next, the controller 8 which controls the entirety of the printer 1 will be explained, with reference to FIG. 2. The controller 8 includes a CPU (Central Processing Unit) 81, a ROM (Read Only Memory) 82, a RAM (Random Access Memory) 83, an ASIC (Application Specific Integrated Circuit) 84, a flash memory 85, etc. The above-described components of the controller 8 cooperate with one another to control the operation of each of the driver IC 6a, the feeding motor 31M, the conveying motor 35M, the moving motor 53M, etc. Note that the signal indicating the moving speed of the rotary blade 52 is inputted to the controller 8 from the encoder 17.

Note that the controller 8 may be configured such that only the CPU 81 performs the various kinds of processing or that only the ASIC 84 performs the various kinds of processing, or that the CPU 81 and the ASIC 84 perform the various kinds of processing in a cooperative manner. Alternatively, the controller 8 may be configured such that one CPU 81 singly performs the processing, or that a plurality of pieces of the CPU 81 perform the processing in a sharing manner. Still alternatively, the controller 8 may be configured such that one ASIC 84 singly performs the processing, or that a plurality of pieces of the ASIC 84 perform the processing in a sharing manner.

Next, a program executed by the controller 8 will be described, with reference to FIGS. 6A and 6B.

First, the controller 8 determines as to whether or not a roll image forming signal for executing a roll paper printing is received from an external device (such as a personal computer, etc.) (step S1). In a case that the controller 8 determines that the roll image forming signal is not received (step S1: NO), the controller 8 repeats the processing of the step S1.

In a case that the controller 8 determines that the roll image forming signal is received (step S1: YES), the controller 8 starts the roll paper printing (step S2). Specifically, in the step S2, the controller 8 causes the conveying part 3 to convey the roll paper Rp in the conveying direction from the feed cassette 2, and causes the head 6 to form an image on the roll paper Rp which is conveyed by the conveying part 3.

After the step S2, the controller 8 determines as to whether or not a cutting objective position of the roll paper Rp has been conveyed to a cutting position (the upper end surface of the vertical part 51a of the fixed blade 51) of the cutting part 5 (step S3). The cutting objective position of the roll paper Rp is derived based on the roll image forming signal received by the controller 8. In a case that the controller 8 determines that the cutting objective position of the roll paper Rp has not been conveyed to the cutting position (step S3: NO), the controller 8 continues the roll paper printing (step S4), and returns the processing to the step S3.

In a case that the controller 8 determines that the cutting objective position of the roll paper Rp has been conveyed to the cutting position (step S3: YES), the controller 8 stops the roll paper printing once, makes “n” to be 0 (zero) (n=0; step S5), further makes “m” to be 0 (zero) (m=0; step S6), and then starts the cutting of the roll paper Rp (step S7: first cutting processing). Specifically, in step S7, the controller 8 drives the moving motor 53M to rotate in the normal direction to thereby cause the rotary blade 52 to move, together with the carriage 54, from the standby position toward the terminal position. In this situation, the controller 8 makes a maximum PWM value (an example of a “power value”) of the moving motor 53M to be 70% (an example of a “first power value”), and causes the rotary blade 52 to move in the cutting direction toward the terminal position (an example of a “first target position”) (see FIG. 7A).

After the step S7, the controller 8 determines, while executing the first cutting processing, as to whether or not the moving speed of the rotary blade 52 is less than a first threshold value (namely, as to whether or not abnormality in the moving state of the rotary blade 52 exists), based on the signal outputted from the encoder 17 (step S8: first determining processing).

In a case that the controller 8 determines that the moving speed of the rotary blade 52 is not less than the first threshold value (step S8: NO), the controller 8 determines as to whether or not the rotary blade 52 has reached the terminal position, based on the signal outputted from the encoder 17 (step S9). In a case that the controller 8 determines that the rotary blade 52 has not reached the termination position (step S9: NO), the controller 8 returns the processing to the step S8.

In a case that the controller 8 determines that the rotary blade 52 has reached the terminal position (step S9: YES), the controller 8 makes the PWM value of the moving motor 53M to be 0 (zero) (namely, stops the power of the moving motor 53M), thereby stopping the rotary blade 52 at the terminal position and ending the cutting of the roll paper Rp (step S10). After the step S10, the controller 8 resumes the roll paper printing, which has been stopped temporarily, with respect to the roll paper Rp having the rear end formed by being cut, and discharges the roll paper Rp on which the image is formed (step S11). After the step S11, the controller 8 ends the program.

In a case that the controller 8 determines that the moving speed of the rotary blade 52 is less than the first threshold value (namely, the controller 8 determines that abnormality in the moving state of the rotary blade 52 exists) (step S8: YES), the controller 8 makes the PWM value of the moving motor 53M to be 0 (zero) % (namely, the controller 8 stops the power of the moving motor 53M), thereby stopping the rotary blade 52 at a first stop position (step S12: a first stopping processing). The “first stop position” is located on the upstream side in the cutting direction with respect to the termination position (first target position). Further, in a case that the PWM value of the moving motor 53M is made to be 0 (zero) %, the rotary blade 52 moves, to some extent, toward the upstream side in the cutting direction due to a reaction force, and thus the “first stop position” is located at the upstream side in the cutting direction with respect to an “abnormality detection position” at which the moving speed of the rotary blade 52 is detected to be less than the first threshold value (namely, at which abnormality of the moving state of the rotary blade 52 is detected to exist) (see FIG. 7A).

Note that a signal which is outputted from the encoder 17 in a case that the moving speed of the rotary blade 52 is determined to be less than the first threshold value (namely, in a case that abnormality of the moving state of the rotary blade 52 is determined to exist) corresponds to a “sign signal” which is a signal indicating a sign that the rotary blade 52 runs onto the fixed blade 51 (a sign of running-on of the rotary blade 52 to the fixed blade 51).

After the step S12, the controller 8 makes “n” to be n+1 (n=n+1; step S13), and determines as to whether or not the “n” exceeds an upper limit number of times A (“A” is a natural number and is, for example, 30 (A=30)) (step S14).

In a case that the controller 8 determines that the “n” exceeds the upper limit number of times A, (step S14: YES), the controller 8 performs an error notification by using a display, a speaker, etc., provided on the printer 1 (step S15), and ends this program.

In a case that the controller 8 determines that the “n” does not exceed the upper limit number of times A, (step S14: NO), the controller 8 determines as to whether or not m=0 (step S16). In a case that the controller 8 determines that m≠0 (step 16: NO), the controller 8 proceeds the processing to a step S21.

In a case that the controller 8 determines that m=0 (step 16: YES), the controller 8 drives the moving motor 53M to rotate in the reverse direction, thereby causing the rotary blade 52 to move toward the upstream side in the cutting direction (step S17: first returning processing). In this situation, the controller 8 causes the rotary blade 52 to stop at a position which is on the upstream side in the cutting direction with respect to the first stop position and which is on the downstream side in the cutting direction with respect to the standby position (see FIG. 7B).

After the step S17, as depicted in FIG. 7C, the controller 8 makes the maximum PWM value (an example of the “power value”) of the moving motor 53M to be 55% (an example of a “third power value”), and causes the rotary blade 52 to move in the cutting direction toward a “third target position” which is on the downstream side in the cutting direction with respect to the first stop position (step S18: third cutting processing).

After the step S18, the controller 8 determines, while executing the third cutting processing, as to whether or not the moving speed of the rotary blade 52 is less than a second threshold value (namely, as to whether or not abnormality in the moving state of the rotary blade 52 exists), based on the signal outputted from the encoder 17 (step S19: second determining processing). The “second threshold value” may be same as or different from the “first threshold value” of the step S8. In a case that the controller 8 determines that the moving speed of the rotary blade 52 is not less than the second threshold value (step S19: NO), the controller 8 repeats the processing of the step S19. Although it is not depicted in the flowchart of FIG. 6B, the controller 8 may determine whether the rotary blade 52 has reached the third target position, after determining “NO” in the step S19 and before executing the step S19 again. In this case, the controller 8 may execute the following process in a case that the rotary blade 52 is determined to have reached the third target position. For example, if the third target position is set to be a position upstream in the cutting direction of the first target position, the controller 8 may move the rotary blade 52 toward the upstream side in the cutting direction a little and then move the rotary blade 52 toward the first target position. Meanwhile, if the third target position is set to be a position identical to the first target position, the controller 8 may end the cutting of the roll paper Rp and discharge the roll paper Rp on which the image is formed, like the steps S10 and S11.

In a case that the controller 8 determines that the moving speed of the rotary blade 52 is less than the second threshold value (namely, in a case that the controller 8 determines that abnormality in the moving state of the rotary blade 52 exists) (step S19: YES), the controller 8 makes the PWM value of the moving motor 53M to be 0 (zero) % (namely, the controller 8 stops the power of the moving motor 53M), thereby stopping the rotary blade 52 at a second stop position (step S20: a second stopping processing). The “second stop position” is located on the upstream side in the cutting direction with respect to the third target position and on the downstream side in the cutting direction with respect to the first stop position, as depicted in FIG. 7C.

After the step S20, the controller 8 drives the moving motor 53M to rotate in the reverse direction, thereby causing the rotary blade 52 to move toward the upstream side in the cutting direction (step S21: third returning processing). In this situation, the controller 8 causes the rotary blade 52 to stop at a position which is on the upstream side in the cutting direction with respect to the second stop position and which is on the downstream side in the cutting direction with respect to the standby position (see FIG. 7D).

After the step S21, the controller 8 makes the maximum PWM value (an example of the “power value”) of the moving motor 53M to be 100% (an example of a “second power value”) and causes the rotary blade 52 to move in the cutting direction from the position on the upstream side in the cutting direction with respect to the first stop position of FIG. 7A toward a “second target position”, as depicted in FIG. 7E (step S22: second cutting processing). The “second target position” is located on the upstream side in the cutting position with respect to the “first target position” and on the downstream side in the cutting direction with respect to the “first stop position”. Further, the “second target position” is located on the downstream side in the cutting direction with respect to the “second stop position”.

After the step S22, the controller 8 determines, while executing the second cutting processing, as to whether or not the rotary blade 52 has stopped at the second stop position (the position on the upstream side in the cutting direction with respect to the second target position), based on the signal outputted from the encoder 17 (step S23: third determining processing).

In a case that the controller 8 determines that the rotary blade 52 has stopped at the second stop position (step S23: YES), the controller 8 makes “m” to be m+1 (m=m+1; step S24), and determines as to whether or not the “m” exceeds an upper limit number of times B (“B” is a natural number which is smaller than the “A”, and is, for example, 5 (B=5)) (step S25). Note that the upper limit number of times A and the upper limit number of times B are set to be A>B because of the following reason. That is, there is possibility that a factor by which the rotary blade 52 stops at the second stop position is not the sheet P, but the printer 1 (a flaw of the fixed blade 51, entering of a foreign matter into the cutting part 5, etc.). In view of such possibility, the upper limit number of times B is set to be smaller than the upper limit number of times A so as to suppress such a situation that the malfunction or damage from becoming worse due to any repeated performance of the returning processing and/or the cutting processing.

In a case that the controller 8 determines that the “m” exceeds the upper limit number of times B, (step S25: YES), the controller 8 performs an error notification by using the display, the speaker, etc., provided on the printer 1 (step S15), and ends this program.

In a case that the controller 8 determines that the “m” does not exceed the upper limit number of times B, (step S25: NO), the controller 8 returns the processing to the step S13. In this case, the controller 8 executes the step S21 (fourth returning processing) and the step S22 (the second cutting processing) again.

In a case that the controller 8 determines that the rotary blade 52 has not stopped at the second stop position (step S23: NO), the controller 8 drives the moving motor 53M to rotate in the reverse direction to thereby cause the rotary blade 52 to move toward the upstream side in the cutting direction (step S26: second returning processing). In this situation, the controller 8 causes the rotary blade 52 to stop at a position which is on the upstream side in the cutting direction with respect to the first stop position and on the downstream side in the cutting direction with respect to the standby position (see FIG. 7F). Note that, in the step S23, the controller 8 may determine that the rotary blade 52 has not stopped at the second stop position based on the determination that the rotary blade 52 has reached the second target position.

After the step S26, the controller 8 returns the processing to the step S6. In this case, the controller 8 executes the step S7 (the first cutting processing) again (see FIG. 7G).

As described above, according to the present embodiment, the controller 8 makes the maximum PWM value (an example of the “power value”) of the moving motor 53M to be 70% which is relatively small (an example of the “first power value”) in the step S7 (the first cutting processing), as depicted in FIG. 7A, thereby making it possible to easily detect abnormality of the moving state (the sign of the running-on) of the rotary blade 52. In a case that abnormality of the moving state (the sign of the running-on) of the rotary blade 52 is detected while the step S7 (the first cutting processing) is being executed, the controller 8 stops the movement of the rotary blade 52 before the running-on occurs (step S12: the first stopping processing). Then, in the step S17 after stopping of the movement (the first returning processing), the controller 8 causes the rotary blade 52 to move toward the upstream side in the cutting direction with respect to the first stop position, as depicted in FIG. 7B. With this, the posture of the rotary blade 52 which tends to cause the running-on is changed, thereby making it possible to return the rotary blade 52 to a normal position. Afterwards, the controller 8 causes the rotary blade 52 to move in the cutting direction from the position on the upstream side in the cutting direction with respect to the first stop position of FIG. 7A toward the “second target position”, while making the maximum PWM value (an example of the “power value”) of the moving motor M53 to be 100% (an example of the “second power value”), with the rotary blade 52 which has been returned to the normal position, as depicted in FIG. 7E (step S22: the second cutting processing). Namely, in the case that abnormality of the moving state of the rotary blade 52 is detected, the controller 8 changes the power value of the moving motor 53M from 70% to 100% (namely, relaxes the power restriction) and then executes the cutting processing. By relaxing the power restriction in such a manner, it is possible to cut, in the step S22 (the second cutting processing), the roll paper Rp up to the position on the downstream side in the cutting direction with respect to the first stop position. Further, by making the “second target position” to be on the upstream side in the cutting direction with respect to the “first target position”, the running-on is less likely to occur in the step S22 (the second cutting processing). Assuming a case where an abnormality could not be detected appropriately and the running-on has occurred. In this case, if the moving distance of the rotary blade 52 in the step S22 is long, the rotary blade 52 having run onto the fixed blade 51 moves the long distance and results in damages on the fixed blade 51 and the rotary blade 52. Meanwhile if the moving distance of the rotary blade 52 in the step S22 is short, the rotary blade 52 having run onto the fixed blade 51 does not move the long distance, and thus the risk of damaging the fixed blade 51 and the rotary blade 52 is reduced. By performing such a control, it is possible to detect sign of the phenomenon of the running-on and to reduce occurrence of this phenomenon.

After the step S22 (the second cutting processing), the controller 8 causes the rotary blade 52 to move toward the upstream side in the cutting direction (step S26: the second returning processing), and then executes the step S7 (the first cutting processing) again (see FIGS. 7E to 7G). With this, it is possible to cut the roll paper Rp in the width direction.

After the step S17 (the first returning processing) and before the step S22 (the second cutting processing), the controller 8 executes the step S18 (the third cutting processing), the step S19 (the second determining processing), the step S20 (the second stopping processing) and the step S21 (the third returning processing) (see FIGS. 7C and 7D). In the step S18 (the third cutting processing), by making the maximum PWM value of the moving motor 53M to be the third power value (55%) which is further smaller than the first power value (70%), it is possible to suppress the movement of the rotary blade 52 due to the reaction force in the step S20 (the second stopping processing), and to determine a cutting terminated position with high precision. Further, by setting the second target position on the downstream side in the cutting direction with respect to the cutting terminated position and by executing the step S22 (the second cutting processing), it is possible to cut the roll paper Rp up to a location on the downstream side in the cutting direction with respect to the second stop position.

In the case that the controller 8 determines that the rotary blade 52 has stopped at the second stop position (the position on the upstream side in the cutting direction with respect to the second target position) while the step S22 (the second cutting processing) is being executed (step S23: YES), the controller 8 causes the rotary blade 52 to move toward the upstream side in the cutting direction (step S21: the fourth returning processing), and then the controller 8 executes step S22 (the second cutting processing) again. With this, in the step S22 (the second cutting processing), it is possible to cut the roll paper Rp up to a location on the downstream side in the cutting direction with respect to the first stop position.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

For example, it is allowable to provide a rotary blade which is movable in the left-right direction together with the rotary blade 52, instead of the fixed blade 51 of the above-described embodiment. Alternatively, it is also allowable to exchange the positions in the front-rear direction of the fixed blade 51 and the rotary blade 52 (namely, the fixed blade 51 may be arranged on the rear side with respect to the rotary blade 52). The first blade may also be a blade which is not rotatable.

Although the cutting part is positioned on the upstream side in the conveying direction with respect to the head in the above-described embodiment, the cutting part may be positioned on the downstream side in the conveying direction with respect to the head.

Although the cutting part is configured to cut the roll paper Rp in the above-described embodiment, the cutting part may cut the cut paper Kp. Further, although the printer in the above-described embodiment selectively accommodates either one the roll body R and the cut paper Kp, the printer may be configured to exclusively accommodate the roll body R or the cut paper Kp and the cutting part may cut the roll body R or the cut paper sheet Kp accommodated in the printer.

Although the moving mechanism is configured to move only the first blade (the rotary blade 52) in the above-described embodiment, the moving mechanism may be configured to move both of the first blade and the second blade.

In the above-described embodiment, although it is determined as to whether or not abnormality in the moving state of the first blade (rotary blade 52) exists, based on the moving speed of the first blade (rotary blade 52), the present disclosure is not limited to this. For example, the determination as to whether or not abnormality in the moving state of the first blade (rotary blade 52) exists may be made based on the load to the actuator (for example, based on the electric current value of the moving motor 53M). The electric current value of the moving motor 53M may be outputted from the electric current value outputting circuit 16 (an example of a “signal outputter”).

The cutting direction is not limited to the direction along the sheet, and may be a direction orthogonal to the sheet.

In the above-described embodiment, although the third target position is on the upstream side in the cutting direction with respect to the first target position, the third target position may be same as the first target position. In the above-described embodiment, although the second target position is on the upstream side in the cutting direction with respect to the first target position, the second target position may be same as the first target position.

In the above-described embodiment, it is allowable to execute the step S22 (the second cutting processing) after the step S17 (the first returning processing), without executing the steps S18 to S21. Namely, the third cutting processing, the second determining processing, the second stopping processing and the third returning processing may be omitted.

The sheet is not limited to the sheet (paper sheet, paper), and may be cloth (fabric), a plastic film, etc.

The present disclosure is also applicable to an electrophotographic printer provided with an image forming part of a laser system in which an electrostatic latent image is formed by exposing a photosensitive body with a laser, an image forming part of an LED system in which an electrostatic latent image is formed by exposing a photosensitive body with an LED, etc., in addition to being applicable to the ink-jet printer. Further, the present disclosure is also applicable to a facsimile machine, a copying machine, a multi-function peripheral, etc., in addition to being applicable to the printer. Furthermore, in the present disclosure, the image forming part is not an essential component, and may be omitted.

What is claimed is:

1. A sheet cutting apparatus comprising:
a conveyor configured to convey a sheet in a conveying direction;
a cutter including a first blade configured to make contact with a first surface of the sheet conveyed by the conveyor, a second blade configured to make contact with a second surface, opposite to the first surface, of the sheet, and a shifter configured to move the first blade in a cutting direction, the cutter being configured to cut the sheet in the cutting direction by cooperation of the first blade and the second blade;
a signal outputter configured to output a signal depending on a moving state of the first blade moved by the shifter; and
a controller,
wherein the shifter includes an actuator configured to apply a power for moving the first blade; and
the controller is configured to execute:
a first cutting processing of moving the first blade in the cutting direction toward a first target position, by setting a power value of the actuator to be a first power value;
a first determining processing of determining whether abnormality in the moving state of the first blade exists or not, based on the signal outputted from the signal outputter, during executing of the first cutting processing;
a first stopping processing of stopping the first blade at a first stop position upstream in the cutting direction of the first target position by stopping the power of the actuator, in a case that the abnormality in the moving state of the first blade is determined to exist in the first determining processing;
a first returning processing of moving the first blade upstream in the cutting direction, after the first stopping processing; and
a second cutting processing of moving the first blade in the cutting direction from a position upstream in the cutting direction of the first stop position toward a second target position by setting the power value of the actuator to be a second power value greater than the first power value, after the first returning processing, the second target position being a position same as the first target position or a position upstream in the cutting direction of the first target position and downstream in the cutting direction of the first stop position.

2. The sheet cutting apparatus according to claim 1, wherein the second target position is the position upstream in the cutting direction of the first target position and downstream in the cutting direction of the first stop position.

3. The sheet cutting apparatus according to claim 2, wherein the controller is configured to execute:
a second returning processing of moving the first blade upstream in the cutting direction, after the second cutting processing; and
the first cutting processing again after the second returning processing.

4. The sheet cutting apparatus according to claim 1, wherein the controller is configured to execute, after the first returning processing and before the second cutting processing:
a third cutting processing of moving the first blade in the cutting direction from a position upstream in the cutting direction of the first stop position toward a third target position downstream in the cutting direction of the first stop position, by setting the power value of the actuator to be a third power value smaller than the first power value;
a second determining processing of determining whether the abnormality in the moving state of the first blade exists or not, based on the signal outputted from the signal outputter, during executing of the third cutting processing;
a second stopping processing of stopping the first blade at a second stop position upstream in the cutting direction of the third target position by stopping the power of the actuator, in a case that the abnormality in the moving state of the first blade is determined to exist in the second determining processing; and
a third returning processing of moving the first blade to a position upstream in the cutting direction of the second stopping position, after the second stopping processing, and
the second stop position is downstream in the cutting direction of the first stop position and upstream side in the cutting direction of the second target position.

5. The sheet cutting apparatus according to claim 4, wherein the controller is configured to execute:
a third determining processing of determining whether or not the first blade is stopped at a position upstream in the cutting direction of the second target position, during executing of the second cutting processing;
a fourth returning processing of moving the first blade upstream in the cutting direction, in a case that the first blade is determined to be stopped at the position upstream in the cutting direction of the second target position in the third determining processing; and
the second cutting processing again after the fourth returning processing.

6. A sheet cutting apparatus comprising:
a conveyor configured to convey a sheet in a conveying direction;
a cutter including a first blade configured to make contact with a first surface of the sheet conveyed by the conveyor, a second blade configured to make contact with a second surface, opposite to the first surface, of the sheet, and a shifter configured to move the first blade in a cutting direction, the cutter being configured to cut the sheet in the cutting direction by cooperation of the first blade and the second blade;
a signal outputter configured to output a sign signal being a signal indicating a sign of running-on of the first blade moved by the shifter to the second blade; and
a controller configured to execute a first stopping processing of stopping the first blade in a case that the controller detects the sign signal.

7. The sheet cutting apparatus according to claim 6 wherein the controller is configured to execute a first cutting processing of moving the first blade in the cutting direction to cut the sheet, and
the signal outputter is configured to output the sign signal based on a moving speed of the first blade or a load of the shifter in the first cutting processing.

8. The sheet cutting apparatus according to claim 7, wherein the controller is configured to execute:
a first returning processing of moving the first blade upstream in the cutting direction after the first stopping processing; and
a second cutting processing of moving the first blade downstream in the cutting direction from a position upstream in the cutting direction of a first stop position at which the first blade is stopped in the first stopping processing, after the first returning processing.

9. The sheet cutting apparatus according to claim 8, wherein the shifter includes an actuator configured to apply a power for moving the first blade, and
a power value of the actuator in the second cutting processing is greater than a power values of the actuator in the first cutting processing.
